(19) United States
(12) Patent Application Publication
(10) Pub. No.: US 2014/0232162 A1
(43) Pub. Date: Aug. 21, 2014

(54) FRAME STRUCTURE OF VEHICLE SEAT

(71) Applicant: TOYOTA BOSHOKU KABUSHIKI KAISHA, Aichi-ken (JP)

(72) Inventor: Atsutaka MITSUHASHI, Aichi-ken (JP)

(73) Assignee: TOYOTA BOSHOKU KABUSHIKI KAISHA, Aichi-ken (JP)

(21) Appl. No.: 14/177,736

(22) Filed: Feb. 11, 2014

(30) Foreign Application Priority Data
Feb. 18, 2013 (JP) 2013-028751

(51) Int. Cl. B60N 2/68

(52) U.S. Cl. CPC B60N 2/68
USPC 297/452.18

(57) ABSTRACT

A frame structure of a vehicle seat includes a frame element in which two metal members are abutted and welded together, end portions of abutted portions of the two metal members being melted by the welding; and a separate metal member provided in a state integrally joined to each of the two metal members so as to sandwich the melted end portions of the two metal members in an abutting direction.

### INCORPORATION BY REFERENCE

The disclosure of Japanese Patent Application No. 2013-028751 filed on Feb. 18, 2013 including the specification, drawings and abstract is incorporated herein by reference in its entirety.

### BACKGROUND OF THE INVENTION

1. Field of the Invention

The invention relates to a frame structure of a vehicle seat. More particularly, the invention relates to a frame structure of a vehicle seat, which has a frame element in which two metal members are abutted and welded together.

2. Description of Related Art

Japanese Patent Application Publication No. 2012-218665 (JP 2012-218665 A) described a frame structure of a vehicle seat, which is formed having a closed sectional shape that has high structural strength, by edge portions of a thin steel sheet that has been pressed and bent into a shape having rectangular cross section being welded together. The welding of this thin steel sheet is performed by the bent edge portions of the thin steel sheet being abutted together and welded from the abutted end portions on one side to the abutted end portions on the other side.

### SUMMARY OF THE INVENTION

However, with the technology described above, the structure is such that a thin steel sheet is welded together (i.e., to itself), so end portions on one side or the other side tend to run due to the welding, so the structural strength tends to decrease. The invention thus provides a frame structure of a vehicle seat, which has a structure in which the structural strength will not easily decrease even if end portions of a frame element run due to welding.

One aspect of the invention relates to a frame structure of a vehicle seat. This frame structure includes a frame element in which two metal members are abutted and welded together, end portions of abutted portions of the two metal members being melted by the welding; and a separate metal member provided in a state integrally joined to each of the two metal members so as to sandwich the melted end portions of the two metal members in an abutting direction.

According to this aspect, as described above, the separate metal member is provided sandwiching, in the abutting direction (i.e., the direction in which the two metal members are abutted), the end portions of the two metal members that form the frame element, so even if the end portions of the two metal members that may be melted do melt due to welding, a decrease in the structural strength of the frame element is able to be prevented by ensuring the structural strength with the separate metal member.

In the aspect described above, the frame element may be a side frame of the vehicle seat, and the separate metal member may be a bracket for connecting the side frame to a separate frame element.

According to this structure, a load applied between the side frame of the vehicle seat and a separate frame element is transferred via the bracket, and thus tends not to be transferred to the end portions, which may be melted, of the two metal members. Therefore, the structural strength of the entire frame structure is able to be better increased.

In the aspect described above, the frame element may be a side frame of a seat back and be formed in a closed sectional shape; and the separate metal member may be joined straddling an upper end portions or a lower end portions of the two metal members of the side frame that abut together and form the closed sectional shape.

According to this structure, the side frame of the seat back that is formed by a thin metal member that is thin enough so that the end portions will run due to welding, is able to be strongly joined at an upper end portions thereof to an upper frame via a separate metal member, and is able to be strongly joined at a lower end portions thereof to a recliner provided between it (i.e., the side frame) and a seat cushion via a separate metal member. Accordingly, the frame structure is able to be both light and strong.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a frame structure of a vehicle seat according to a first example embodiment of the invention;

FIG. 2 is a partial perspective view of a side frame on a vehicle outside of a seat back;

FIG. 3 is a perspective view showing the components in FIG. 2 in an assembled state;

FIG. 4 is a front view of the frame structure of the vehicle seat;

FIG. 5 is a side view of the frame structure of the vehicle seat;

FIG. 6 is a sectional view taken along line VI-VI in FIG. 4;

FIG. 7 is a sectional view taken along line VII-VII in FIG. 4;

FIG. 8 is a perspective view of a frame structure of a vehicle seat according to a second example embodiment of the invention; and

FIG. 9 is a front view of the frame structure of the vehicle seat.

### DETAILED DESCRIPTION OF EMBODIMENTS

Hereinafter, modes (i.e., example embodiments) for carrying out the invention will be described with reference to the accompanying drawings.

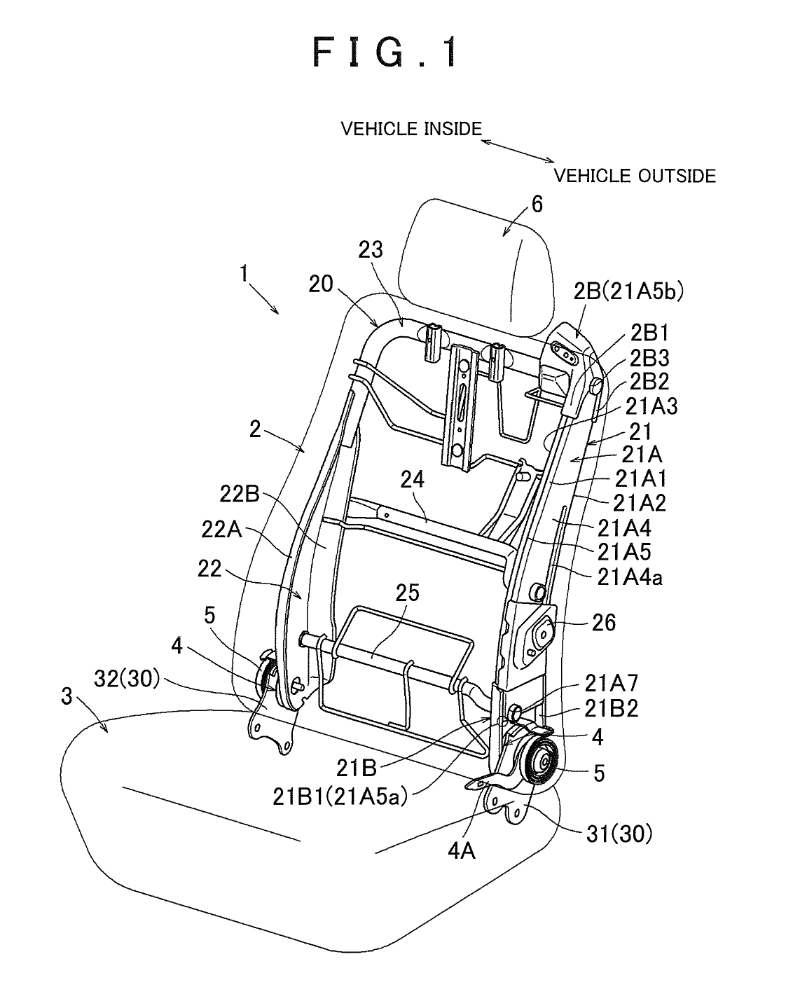

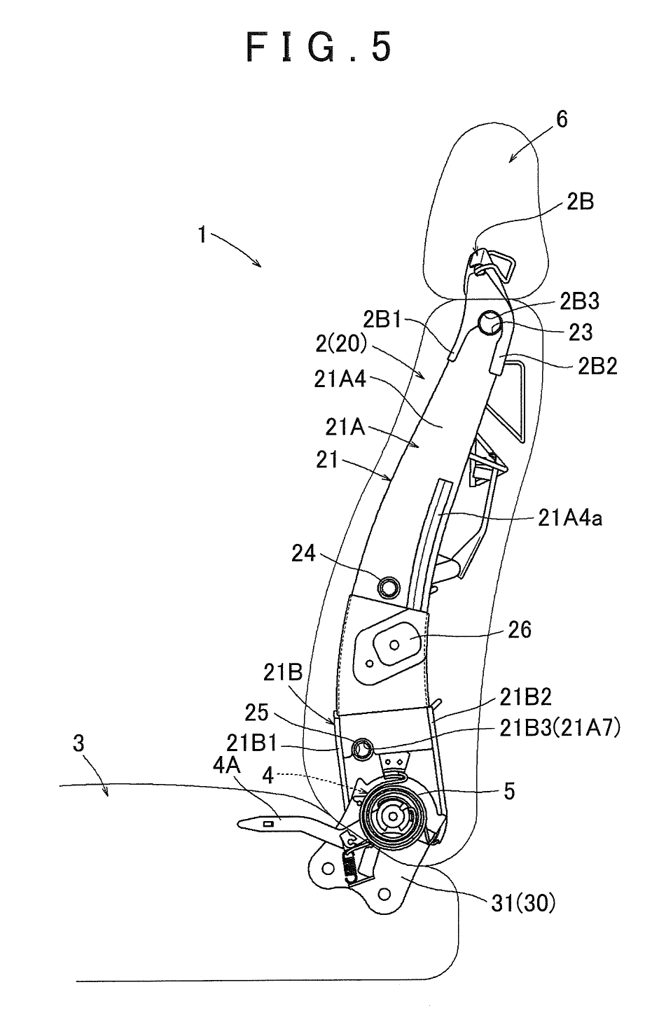

First, a frame structure of a vehicle seat according to a first example embodiment of the invention will be described with reference to FIGS. 1 to 7. The frame structure of a vehicle seat in this example embodiment is applied to a seat 1 of an automobile, as shown in FIG. 1. This seat 1 includes a seat back 2 that serves as a backrest for a seated occupant, a seat cushion 3 that serves as a seating portion, and a headrest 6 that serves as a headrest. The seat back 2 is supported connected to a rear portion of the seat cushion 3, the seat cushion 3 is supported connected to a floor of a vehicle, and the headrest 6 is supported attached to an upper portion of the seat back 2.

More specifically, lower end portions on both the left and right sides of the seat back 2 are connected, via disk-shaped recliners 4 that function as rotating shaft devices that can be stopped from rotating, to rear end portions on both the left and right sides of the seat cushion 3. As a result, the seat back 2 is able to be freely tilted forward and backward at a backrest angle with respect to the seat cushion 3, and fixed at each tilted position.

The recliners 4 keep the backrest angle of the seat back 2 always in a fixed state (a locked state). These fixed states are released all together by an operating lever 4A provided on a side portion on a vehicle outside (i.e., the right side when facing the paper on which FIG. 1 is drawn) of the seat cushion 3 being pulled up, thus enabling the backrest angle of the seat back 2 to be able to be freely adjusted. Spiral springs 5 are hooked between connecting portions that are connected to the seat cushion 3 on both the left and right sides of the seat back 2 described above. When the seat back angle of the seat back 2 is adjusted, the seat back 2 is able to be raised forward to a position abutting against the back of a seated occupant by the urging force of the spiral springs 5. As a result, when the backrest angle of the seat back 2 is adjusted, the seat back 2 moves with the movement of the back of the seated occupant, so the adjustment operation of the seat back angle is able to be performed easily. The basic structure of the recliners 4 described above is a well-known structure described in Japanese Patent Application Publication No. 2011-116303 (JP 2011-116303 A), so a description thereof will be omitted.

The seat 1 described above is equipped with a three-point seatbelt apparatus, not shown, for restraining the body of the seated occupant. More specifically, a retractor that is a device for winding up webbing of the seatbelt apparatus, not shown, is provided in the seat back 2, and a belt guide 2B for pulling out the webbing that has been pulled out from the retractor, to the front side of the seat back 2, is provided on a shoulder section on the vehicle outside of the seat back 2. Also, an end portion of a tip of the webbing, not shown, that has been pulled out from the belt guide 2B is provided fastened to a side portion on the vehicle outside of the seat cushion 3. The webbing retained in a state strung across the chest and waist of the seated occupant, by the seated occupant drawing a mid-section of the webbing that has been pulled out from the belt guide 2B toward the vehicle inside of the seat cushion 3 (i.e., to the left when facing the paper on which FIG. 1 is drawn), and inserting a tongue plate through which the webbing passes into a buckle provided on a side portion on the vehicle inside of the seat cushion 3. The basic structure of the seatbelt apparatus provided on the seat back 2 is a well-known structure described in Japanese Patent Application Publication No. 2011-131697 (JP 2011-131697 A), so a description of the specific structure thereof will be omitted.

As described above, with a structure in which a seatbelt apparatus is provided on the seat back 2 in this way, when a frontal impact or the like of the vehicle occurs and a strong impact force is received such that the seated occupant is thrown to the seat front side by the momentum, for example, a strong tensile force is applied toward the seat front side to the webbing that is supporting the body of the occupant. Therefore, a strong tensile force that attempts to push and bend the shoulder section (i.e., the belt guide 2B) on the vehicle outside of the seat back 2 that serves as the outlet for the webbing toward the seat front side about a fixed point supported by the recliner 4 on a lower end side of this shoulder section is applied to the shoulder section. Therefore, the frame structure of a side portion on the vehicle outside of the seat back 2 in this example embodiment is a structure in which a side frame 21 on the same side is made to have high structural strength such that, even if a strong bending load such as that described above is received, the side frame 21 will not easily bend and deform. Hereinafter, the frame structure of the seat back 2 will be described in more detail.

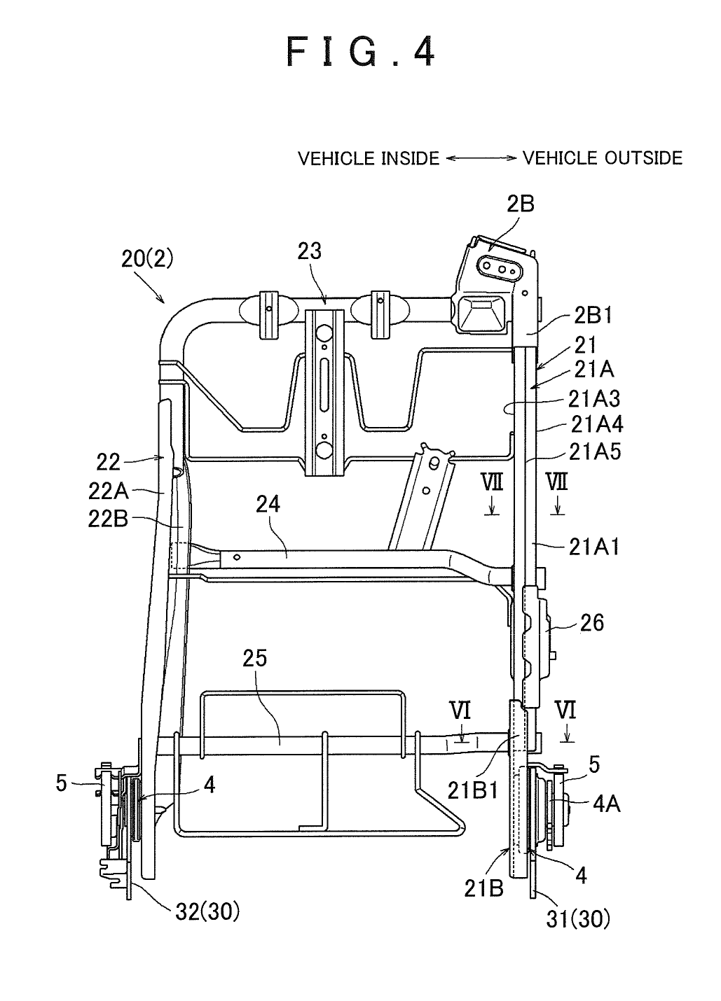

That is, the seat back 2 has an internal frame structure that is formed by a back frame 20 formed in an inverted U-shape, as shown in FIGS. 1 and 4. The back frame 20 is formed in an integrated inverted U-shape by vertically long plate-shaped side frames 21 and 22 that form frames on both the left and right side portions of the seat back 2, and a horizontally long upper pipe 23 that forms a frame of an upper portion of the seat back 2 that extends between upper end portions of these side frames 21 and 22. The side frames 21 and 22 are each formed by a steel sheet member that has been cut into a vertically long shape.

Also, the upper pipe 23 is formed by a round steel pipe that has been bent into an L-shape. An end portion of the upper pipe 23 that has been bent downward on the vehicle inside is placed so as to surface-abut with an inner peripheral surface of a portion formed on an upper end portion of the side frame 22 on the same side, which has been narrowed down to a semicircular shape, and the two (i.e., the downward-bent end portion of the upper pipe 23 and the inner peripheral surface of the semicircular-shaped portion) are integrally and strongly joined together by welding. Also, an end portion of the upper pipe 23 that is formed extending straight in a seat width direction on the vehicle outside is placed so as to surface-abut with an inner peripheral surface (an upper surface) of a half-moon hole 21A6 formed on an upper end portion of the side frame 21 on the same side, and is welded thereto. This end portion of the upper pipe 23 is also integrally and strongly joined to the side frame 21 on the same side by welding via the belt guide 2B described above.

More specifically, the belt guide 2B has a through-hole 2B3 formed recessed in a round hole shape from a lower side so as to enable the upper pipe 23 to pass through it in the seat width direction, and a front leg portion 2B1 and a rear leg portion 2B2 that are assembled in states placed against a front wall portion 21A1 and a rear wall portion 21A2, respectively, of an angular tube frame 21A, that will be described later, of the side frame 21 on the vehicle outside. With the upper pipe 23 passing through the through-hole 2B3, and the front leg portion 2B1 and the rear leg portion 2B2 placed against the front wall portion 21A1 and the rear wall portion 21A2, respectively, of the side frame 21 on the vehicle outside, the belt guide 2B is integrally and strongly joined to the upper pipe 23 and the side frame 21 on the vehicle outside by edge portions on the left and right sides where the upper pipe 23 abuts against the through-hole 2B3, and edge portions where the front leg portion 2B1 and the through-hole 2B3 abut against the front wall portion 21A1 and the rear wall portion 21A2 of the side frame 21, being arc-welded.

Each of the side frames 21 and 22 is formed bent toward the seat rear side such that an upper region thereof forms a shape that curves in an arc toward the seat rear side with respect to a lower region. By forming the side frames 21 and 22 in this kind of shape, the portions that support the lower back of a seated occupant from the outside on both sides are formed in shapes that greatly protrude out toward the seat front side, thus enabling an area near the lower back of the seated occupant to be firmly supported at the sides from the outside on both sides. Also, by forming the side frames 21 and 22 in shapes curved in an arc toward the seat rear side, the side frames 21 and 22 are able to ensure a large amount of knee space for an occupant seated in a seat behind this seat.

Here, for the side frame 22 on the vehicle inside of the back frame 20 described above, a thin steel sheet that is 1.2 mm thick is first cut curved in the arc-shape described above, and then edge portions on the front and rear sides (i.e., flange portions 22A and 22B) are formed in a sectional U-shape that is bent to the seat inside. The recliner 4 described above is joined to an outside surface in a lower region of the side frame 22 on the vehicle inside, and the side frame 22 is joined via this recliner 4 to an inside surface of a side frame 32 on the same side of the cushion frame 30 that forms the frame of the seat cushion 3.

Meanwhile, the side frame 21 on the vehicle outside is formed by an angular tube frame 21A formed by a thin steel sheet that is 1.2 mm thick and is bent in an angular tube shape, in combination with a thick sheet frame 21B formed by a thick steel sheet that is 4 mm thick and is joined to a lower portion of the angular tube frame 21A. Here, the angular tube frame 21A is an example of a frame element of the invention, the thick sheet frame 21B is an example of a separate metal member of the invention, and the recliner 4 is an example of another frame element of the invention.

For the angular tube frame 21A, a thin steel sheet is first cut in a vertically long shape, and then the entire cut sheet is bent into a shape having a rectangular cross-section (i.e., a rectangular sectional shape). Edge portions of the bent tips are then abutted together and integrally joined by laser welding. As a result, the angular tube frame 21A is formed in an angular tube shape with a closed cross-section that has high structural strength with respect to bending and twisting.

After the angular tube frame 21A is bent into an angular tube shape and joined together in this way, the entire angular tube frame 21A is bent into an arc-shape that arcs toward the seat rear side by press-forming. Here, the steel sheet member that forms the angular tube frame 21A is formed by a high tensile steel sheet having high structural strength with respect to bending and twisting. Therefore, when a structure formed in an angular tube shape with a closed cross-section that is formed from such a high strength member is curved in an arc in this way, forming defects such as wrinkles or cracks may occur at the bent portion because the ductility of the high strength member is low.

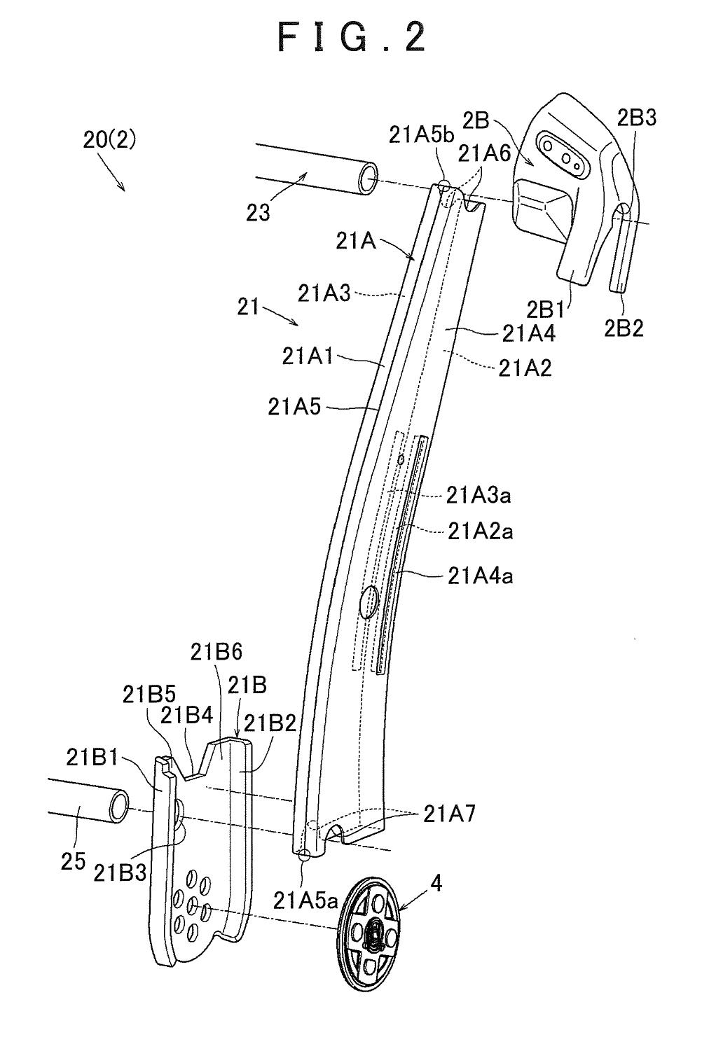

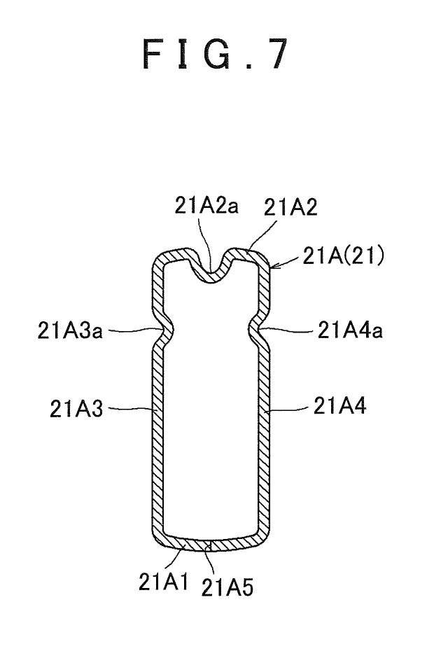

Therefore, in order to inhibit the forming defects described above from occurring, recessed strips 21A2a, 21A3a, and 21A4a that are recessed in striated shapes in the longitudinal direction toward the inside of the angular tube are formed in advance (i.e., at the time of press-forming) on an inside wall portion 21A3, an outside wall portion 21A4, and the rear wall portion 21A2, respectively, that receive in-plane stress in a compression direction when bent in an arc (see FIGS. 2 and 7). By forming these recessed strips 21A2a, 21A3a, and 21A4a, the compression deformation amounts of the rear wall portion 21A2, the inside wall portion 21A3, and the outside wall portion 21A4 that receive in-plane stress in the compression direction due to the angular tube frame 21A being curved in an arc as described above concentrate at the locations where the recessed strips 21A2a, 21A3a, and 21A4a are formed and are thus relieved, so forming defects such as wrinkles and cracks will not occur on the general surfaces of the wall portions 21A2 to 21A4. Therefore, the angular tube frame 21A is able to be formed in a shape smoothly curved in an arc with no forming defects such as wrinkles or cracks.

Here, a joint 21A5 of the edge portions of the angular tube frame 21A that are bent into an angular tube shape and joined together is formed in a shape extending straight in a height direction along a center line in a width direction of the front wall portion 21A1 that faces the seat front side. By forming the joint 21A5 so that it is on the front wall portion 21A1 in this way, the front wall portion 21A1 will only receive in-plane stress in a tensile direction when the angular tube frame 21A is curved in an arc, so the recessed strips 21A2a, 21A3a, and 21A4a for relieving the in-plane stress in the compression direction described above are suitably formed on the other wall portions where there are no joints, i.e., on the rear wall portion 21A2, the inside wall portion 21A3, and the outside wall portion 21A4, thus enabling the angular tube frame 21A to be formed in a shape that curves smoothly without causing forming defects such as wrinkles or cracks to occur. The recessed strips 21A2a, 21A3a, and 21A4a are formed only in a middle region in the height direction, which is bent in an arc, of the rear wall portion 21A2, the inside wall portion 21A3, and the outside wall portion 21A4, and are not formed in an upper region or a lower region that remain straight, i.e., that are not bent in an arc.

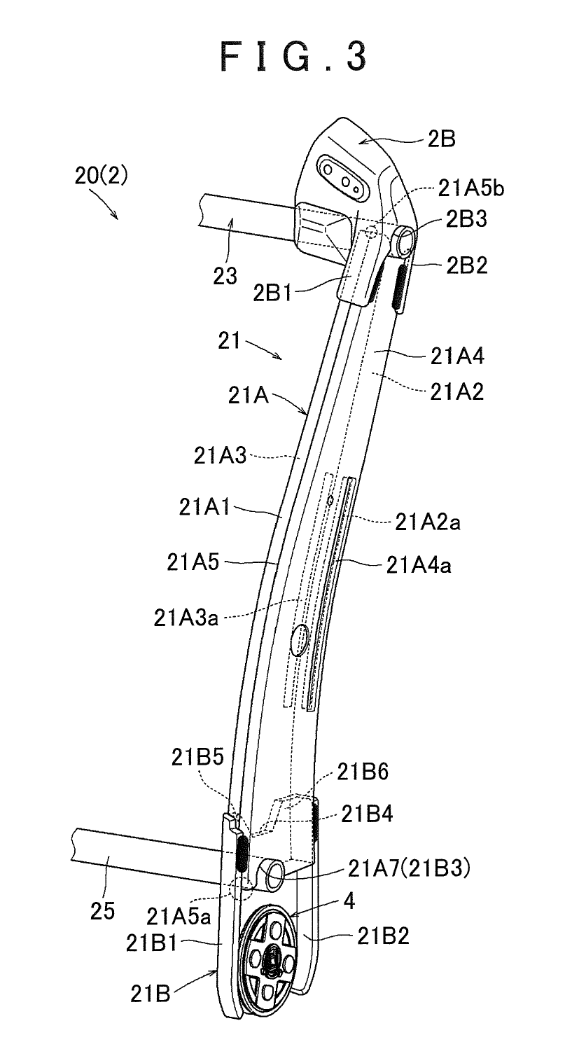

As shown in FIGS. 2 and 3, the thick sheet frame 21B is formed by a thick steel sheet that has high structural strength and is thicker than the angular tube frame 21A described above. This thick sheet frame 21B is placed against a lower portion of the angular tube frame 21A, and is integrally and strongly joined thereto by welding. More specifically, with an upper region of the sheet surface of the thick sheet frame 21 B placed against a lower region of the inside wall portion 21A3 of the angular tube frame 21A, an upper edge portion of the thick sheet frame 21B and a sheet surface portion of the thick sheet frame 21B against which a lower end portion of the inside wall portion 21A3 is placed, are each integrally joined by arc-welding to portions against which the angular tube frame 21A is placed.

Also, with a front flange portion 21B1 and a rear flange portion 21B2, which are formed bent in the seat width direction on a front edge portion and a rear edge portion, respectively, of the thick sheet frame, placed against the front wall portion 21A1 and the rear wall portion 21A2, respectively, of the angular tube frame 21A, edge portions of the bent tips are integrally joined by arc-welding to portions of the front wall portion 21A1 and the rear wall portion 21A2 against which they (i.e., the edge portions) are placed.

Specifically, the front flange portion 21B1 extends in the width direction to a position beyond the joint 21A5, which formed in the center portion in the width direction of the front wall portion 21A1 of the angular tube frame 21A, so as to cover the joint 21A5, and the edge portion of the extending tip is integrally joined to the front wall portion 21A1 by arc-welding. More specifically, the arc-welding of the front flange portion 21B1 and the front wall portion 21A1 is performed along an edge side portion where they both abut, from a position at least 7 mm above the lower end portion of the front wall portion 21A1, such that the lower end portion of the front wall portion 21A1 formed by the thin steel sheet will not run due to welding.

By having the thick sheet frame 21B welded to the front wall portion 21A1 in a state in which the front flange portion 21B1 covers the joint 21A5 of the front wall portion 21A1 as described above, the thick sheet frame 21B is integrally joined at positions straddling the joint 21A5 of the front wall portion 21A1. As a result, a lower end portion 21A5a of the joint 21A5 of the angular tube frame 21A is covered by the front wall portion 21B1 of the thick sheet frame 21B, so even if the lower end portion 21A5a of the joint 21A5 ends up running due to the fact that it (i.e., the lower end portion 21A5a) is thin steel sheet when laser welding is performed, a decrease in the structural strength of the angular tube frame 21A is able to be prevented by the structural strength of the thick sheet frame 21B that straddles and covers this portion.

Specifically, with the sheet surface of the thick sheet frame 21B placed against the inside wall portion 21A3 of the angular tube frame 21A, the front flange portion 21B1 of the thick sheet frame 21B is integrally welded to a surface portion of a tip across the joint 21A5 of the front wall portion 21A1, after which the rear flange portion 21B2 of the thick sheet frame 21B is then integrally welded to the rear wall portion 21A2 of the angular tube frame 21A. Therefore, the joint 21A5 is firmly restrained by the thick sheet frame 21B so as not to deform in the direction in which it (i.e., the joint 21A5) will tear apart (i.e., in the width direction). As a result, a load applied in various directions that is input to the side frame 21 is able to be suitably transferred and supported through a region that has high structural strength, without passing through the lower end portion 21A5a, which has run, of the joint 21A5, between the angular tube frame 21A and the thick sheet frame 21B.

Also, the belt guide 2B that is joined to the upper end portion of the angular tube frame 21A is also placed straddling, i.e., sandwiching, the joint 21A5 in the width direction, and is integrally joined to the angular tube frame 21A at positions straddling the joint 21A5, similar to the thick sheet frame 21B. Here, the belt guide 2B is an example of a separate metal member of the invention. More specifically, a front leg portion 2B1 of the belt guide 2B is placed in a state surface-abutted against the front wall portion 21A1 of the angular tube frame 21A, and portions bent toward the seat rear side that are formed on edge portions on both the left and right sides are placed against, and arc-welded to, the inside wall surface 21A3 and the outside wall surface 21A4 of the angular tube frame 21A, such that the belt guide 2B is integrally joined to the angular tube frame 21A. As a result, an upper end portion 21A5b of the joint 21A5 of the angular tube frame 21A is covered by the front leg portion 2B1 of the belt guide 2B, so even if the upper end portion 21A5b of the joint 21A5 ends up running due the fact that it (i.e., the upper end portion 21A5b) is thin steel sheet when laser welding is performed, a decrease in the structural strength of the angular tube frame 21A is able to be prevented by the structural strength of the front leg portion 2B1 that straddles and covers this portion.

Specifically, with the front leg portion 2B1 of the belt guide 2B placed against the front wall portion 21A1 of the angular tube frame 21A, the joint 21A5 is firmly restrained by the belt guide 2B so as not to deform in the direction in which it (i.e., the joint 21A5) will tear apart (i.e., in the width direction). As a result, a load applied in various directions that is input between the upper pipe 23 and the side frame 21 is able to be suitably transferred and supported through the region that has high structural strength, without passing through the upper end portion 21A5b of the joint 21A5 that has run as described above, between the angular tube frame 21A and the belt guide 2B.

The recliner 4 is joined to the outside surface of the thick sheet frame 21B, and the side frame 21 is joined via this recliner 4 to the inside surface of a side frame 31, on the same side, of the cushion frame 30 that forms the inner frame of the seat cushion 3. By having the recliner 4 be joined to the thick sheet frame 21B in this way, higher joining strength is able to be displayed compared to when the recliner 4 is provided joined to the thin steel sheet. In addition, the structural strength of the lower end side region of the side frame 21 that receives the largest bending load when a large load is input to the seat back 2 is effectively ensured by the thick sheet frame 21B.

Here, as shown in FIG. 2, a recessed portion 21B4 that is recessed downward is formed in a center portion of an upper edge portion of the surface portion that is placed against the inside wall portion 21A3 of the thick sheet frame 21B. This recessed portion 21B4 mitigates a change in a section modulus generated at a boundary region between the angular tube frame 21A and a portion where the thick sheet frame 21B is joined to the angular tube frame 21A. More specifically, the recessed portion 21B4 is formed with stepped side surfaces, which drop toward a bottom surface of the recessed shape, being inclined surfaces that are more gently inclined than a right angle. The inclined shape of this recessed portion 21B4 enables a change in the section modulus generated at the boundary region to be mitigated more gently.

Therefore, with the structure described above, the side frame 21 on the vehicle outside is a structure having high structural strength, with the structural strength in the lower region that is particularly susceptible to receiving a load of a bending moment being ensured by the thick sheet frame 21B. At the same time, a decrease in the structural strength that accompanies an abrupt change in the section modulus between the angular tube frame 21A and the portion where the thick sheet frame 21B is joined to the angular tube frame 21A will not occur, so high bearing power that enables an input load to be widely received by the entire structure without stress concentrating locally is able to be displayed. Therefore, when a large load is input to the side frame 21 from the vehicle outside, such as when a side collision of the vehicle occurs, this load is widely received by the entire structure without stress concentrating locally, so it takes a longer amount of time until the side frame 21 bends to the point where it buckles. In this way, the frame structure of this example embodiment is a structure that is able to be both light and strong by suitably using the light angular tube frame 21A that is made of thin steel sheet, in combination with the strong thick sheet frame 21B that is made of thick steel sheet.

Further, the thick sheet frame 21B is foamed with the recessed portion 21B4 being formed on a center upper edge portion of the thick sheet frame 21B, while leaving a shaped portion 21B5 on the front side and a shaped portion 21B6 on the rear side, on portions on the front and rear sides sandwiching this recessed portion 21B4 in between. Therefore, when a large load in the front-rear direction is input to the seat back 2, the lower end portion of the angular tube frame 21A is able to be strongly supported from the lower side by the shaped portion 21B5 on the front side and the shaped portion 21B6 on the rear side of the thick sheet frame 21B.

Also, by having the angular tube frame 21A and the recliner 4 be placed against, and joined to, the side surface on the same side (i.e., the outside) of the thick sheet frame 21B, the thickness in the width direction of the angular tube frame 21A that has a closed sectional shape overlaps with the thickness of the recliner 4, at the same position in the width direction, so the space in which these three members are arranged in the width direction is able to be kept small. In this way, the frame structure of the side frame 21 provided with the angular tube frame 21A that has high structural strength and a closed sectional shape is able to be made compact in the width direction. Also, an armrest support bracket 26 for attaching and supporting an armrest device, not shown, is integrally joined to the outside wall portion 21A4 of the angular tube frame 21A (see FIGS. 1, 4, and 5). The support strength with which the armrest support bracket 26 is supported is ensured by the high structural strength of the angular tube frame 21A that has the closed sectional shape described above.

Also, as shown in FIGS. 1 and 4, in addition to the upper pipe 23, two reinforcing pipes 24 and 25, each of which is formed by circular steel pipe that is bent in a crank shape, extend in the seat width direction between middle portions and lower portions in the height direction of the side frame 22 on the vehicle inside and the side frame 21 on the vehicle outside, and are rigidly-connected thereto. An end portion on the vehicle inside of the reinforcing pipe 24 that extends between the middle portions of the side frames 21 and 22 is crushed into a plate shape and placed from the seat rear side against the flange portion 22B that is bent on the rear edge side of the side frame 22 on the same side. In this state, this inside end portion of the reinforcing pipe 24 is integrally joined to the flange portion 22B by welding. An end portion on the vehicle outside is inserted through the inside wall portion 21A3 and the outside wall portion 21A4 of the angular tube frame 21A that forms the side frame 21 on the same side. In this state, this outside end portion of the reinforcing pipe 24 is integrally and strongly joined by welding to these portions through which it is inserted (i.e., the inside wall portion 21A3 and the outside wall portion 21A4 of the angular tube frame 21A).

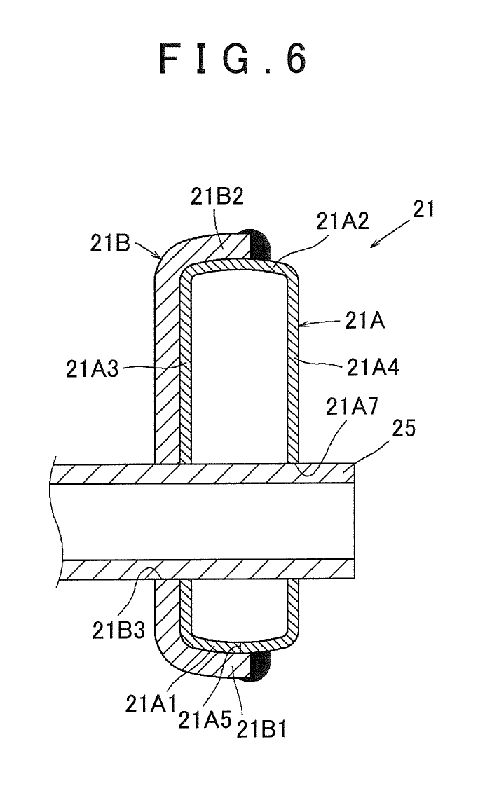

Also, an end portion on the vehicle inside of the reinforcing pipe 25 that extends between the lower portions of the side frames 21 and 22 is inserted through the side frame 22 on the same side. In this state, this inside end portion is integrally and strongly joined by welding to the portion through which it is inserted (i.e., the side frame 22). The end portion on the vehicle outside of the reinforcing pipe 25 is inserted through a joining portion of the angular tube frame 21A and the thick sheet frame 21B that form the side frame 21 on the same side. In this state, this outside end portion is integrally and strongly joined by welding to the portions through which it is inserted (i.e., the angular tube frame 21A and the thick sheet frame 21B) (see FIG. 6). More specifically, the end portion of the vehicle outside of the reinforcing pipe 25 is inserted through a round hole 21B3 formed in the thick sheet frame 21B, and a half-moon hole 21A7 formed in the lower end portion of the angular tube frame 21A, and is integrally and strongly joined by welding to these portions through which it is inserted (i.e., the round hole 21B3 and the half-moon hole 21A7). The entire back frame 20 is joined together in a ladder-shape that has high structural strength with respect to bending and twisting, by the joining of the reinforcing pipes 24 and 25.

In this way, the frame structure of this example embodiment is a structure in which the angular tube frame 21A that forms the side frame 21 on the vehicle outside of the seat back 2, is joined in an angular tube shape having a closed cross section, by a thin steel sheet being bent into a shape having a rectangular cross-section, and the two bent edge portions being abutted and laser-welded together. In this way, the frame structure of the example embodiment has a frame element (i.e., the angular tube frame 21A) in which two metal members are abutted and welded together, and this frame element (i.e., the angular tube frame 21A) is a structure in which the end portions of portions of the two metal members that abut together (i.e., the lower end portion 21A5a and the upper end portion 21A5b) may run due to welding. Also, with this frame structure, separate metal members (i.e., the thick sheet frame 21B and the belt guide 2B) are provided in a state integrally joined to one metal member and the other metal member so as to sandwich, in the abutting direction, the end portions (the lower end portion 21A5a and the upper end portion 21A5b) of the two metal members that may run. By providing the separate metal members (i.e., the thick sheet frame 21B and the belt guide 2B) sandwiching, in the abutting direction, the end portions (i.e., the lower end portion 21A5a and the upper end portion 21A5b) of the two metal members that form the frame element (i.e., the angular tube frame 21A) in this way, even if the end portions (i.e., the lower end portion 21A5a and the upper end portion 21A5b) of the two metal members that may run do in fact run due to welding, a decrease in the structural strength of the frame element (i.e., the angular tube frame 21A) is able to be prevented by ensuring the structural strength with the separate metal members (i.e., the thick sheet frame 21B and the belt guide 2B).

Also, the frame element (i.e., the angular tube frame 21A) is configured as the side frame 21 of the seat back 2 of the vehicle seat 1, and the separate metal members (i.e., the thick sheet frame 21B and the belt guide 2B) are configured as brackets for connecting the side frame 21 to other frame elements (i.e., the recliner 4 and the upper pipe 23). According to this kind of structure, a load applied between the side frame 21 of the seat back 2 of the vehicle seat 1 and the separate frame elements (i.e., the recliner 4 and the upper pipe 23) is transferred via the separate metal members (i.e., the thick sheet frame 21B and the belt guide 2B) that are the brackets, and tends not to be transferred to the end portions (i.e., the lower end portion 21A5a and the upper end portion 21A5b) of the two metal members that may run. Therefore, the structural strength of the entire frame structure is able to be better increased.

Also, the frame element (i.e., the angular tube frame 21A) is configured as a portion of the side frame 21 that is formed in a closed sectional shape of the seat back 2, and the separate metal members (i.e., the thick sheet frame 21B and the belt guide 2B) are joined straddling the upper end portions and the lower end portions of the two metal members that abut together and form a closed sectional shape of the frame element (i.e., the angular tube frame 21A). According to this kind of structure, the side frame (i.e., the angular tube frame 21A) of the seat back 2 that is formed by the thin metal member that is thin enough so that the end portions will run due to welding, is able to be strongly joined at an upper end portion thereof to the upper pipe 23 via a separate metal member (i.e., the belt guide 2B), and is able to be strongly joined at a lower end portion thereof to the recliner 4 provided between it (i.e., the angular tube frame 21A) and the seat cushion 3 via a separate metal member (i.e., the thick sheet frame 21B). Accordingly, the frame structure is able to be both light and strong.

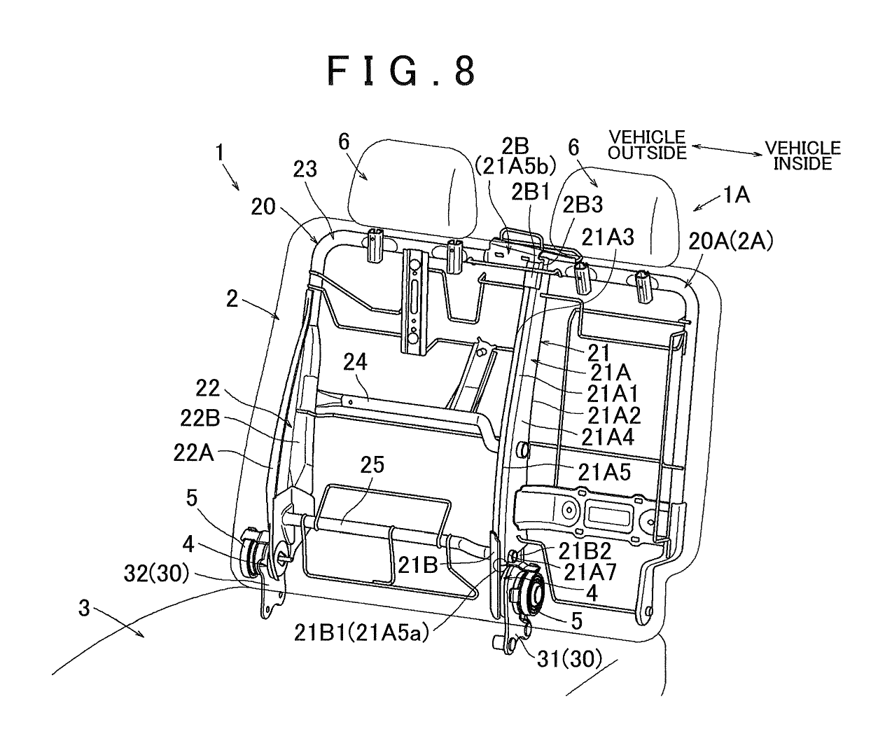

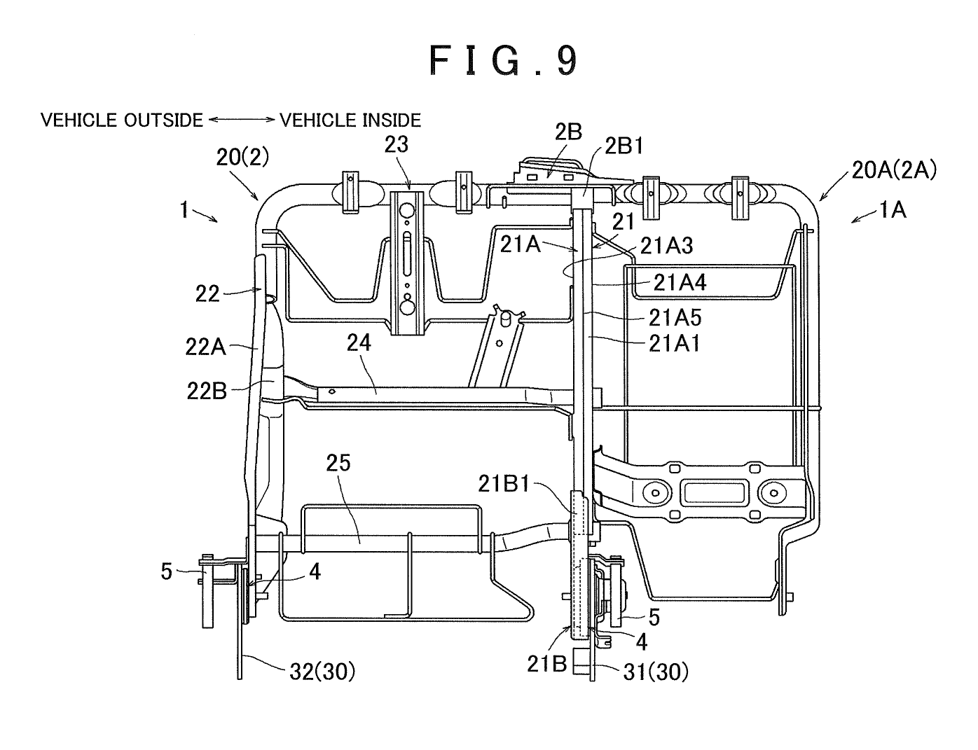

Continuing on, a frame structure of a vehicle seat according to a second example embodiment of the invention will now be described with reference to FIGS. 8 and 9. In this example embodiment, locations where the substantive structure and operation are the same as they are in the frame structure of the vehicle seat described in the first example embodiment will be denoted by the same reference characters and descriptions of these locations will be omitted. Structure that is different will be described in detail. The seat 1 in this example embodiment is configured as a seat for sitting that is arranged in the rearmost row in a vehicle provided with three rows of seats, as shown in FIGS. 8 and 9. The seat 1 is configured as a two-person seat on a wide side (i.e., the 60 split side) of a three-person seat with a 60/40 split set in the same row. The structure of a narrow (in the width direction) center seat 1A is integrally provided on a side portion on the vehicle inside of the seat 1.

More specifically, the seat 1 is configured such that a back frame 20A that forms an inner frame of a seat back 2A of the center seat 1A is integrally joined to the side frame 21 on the vehicle inside of the back frame 20 that is formed in an inverted U-shape. As a result of the back frame 20A being joined to the side frame 21, the back frame 20A of the center seat 1A is supported in a cantilevered manner by the side frame 21 on the vehicle inside. Therefore, the side frame 21 on the vehicle inside must be a structure with high structural strength that is also strong enough to support the back frame 20A of the center seat 1A. The detailed structure of the side frame 21 on the vehicle inside is substantially the same as that of the side frame 21 on the vehicle outside described in the first example embodiment, so a description thereof will be omitted. Structure in the drawings that is denoted by the same reference characters as the side frame 22 on the vehicle outside described in the first example embodiment, displays substantially the same structure and operation as the side frame 22 on the vehicle inside described in the first example embodiment.

While the modes for carrying out the invention have been described using two example embodiments, the invention may also be carried out in various other modes aside from those of the example embodiments described above. For example, the frame structure of a vehicle seat of the invention may be applied to any kind of seat, such as a driver seat, a front passenger seat, or a rear seat of an automobile. In addition, the frame structure of a vehicle seat of the invention may also be applied to a seat applied to a vehicle other than an automobile, such as a train or the like. Moreover, the frame structure of a vehicle seat of the invention may be broadly applied to a seat provided for various types of vehicles such as aircraft and marine vessels and the like.

Also, the frame structure of the invention may also be applied to a frame structure of another seat structure member other than a seat back of a vehicle seat, such as a seat cushion or a headrest or the like. Also, the frame structure of the invention may be applied to any kind of frame structure as long as it is a frame structure that has a frame element in which two metal members are abutted and welded together, such as a variety of reinforcing structures, a seat retractor, an ottoman, or a slide rail provided in a vehicle seat.

Also, in the example embodiments described above, each edge portion on the tip end side that is bent in a rectangular sectional shape, of the angular tube frame 21A that is formed by substantially one sheet is given as an example of the “two metal members that are abutted and welded together”, but the “two metal members” may also be formed from metal members that are separate from each other. Also, the abutting direction of the “two metal members” may be an in-plane direction of these metal members, or an out-of-plane direction of these metal members. Also, the welding performed with the two metal members abutted together, and the welding that integrally joins the separate metal members to these two metal members may each be laser welding or arc-welding.

What is claimed is:

1. A frame structure of a vehicle seat, comprising:
a frame element in which two metal members are abutted and welded together, end portions of abutted portions of the two metal members being melted by the welding; and
a separate metal member provided in a state integrally joined to each of the two metal members so as to sandwich the melted end portions of the two metal members in an abutting direction.

2. The frame structure according to claim 1, wherein
the frame element is a side frame of the vehicle seat, and the separate metal member is a bracket for connecting the side frame to a separate frame element.

3. The frame structure according to claim 2, wherein
the frame element is a side frame of a seat back and is formed in a closed sectional shape; and
the separate metal member is joined straddling upper end portions or lower end portions of the two metal members of the side frame that abut together and form the closed sectional shape.
